(19) United States
(12) Patent Application Publication
(10) Pub. No.: US 2009/0050337 A1
(43) Pub. Date: Feb. 26, 2009

(54) SELECTABLE MODE TEST AND DRAIN MODULE

(75) Inventors: Heng Yung, Stewartsville, NJ (US); Richard R. Weston, Nazareth, PA (US)

Correspondence Address: Ballard Spahr Andrews & Ingersoll, LLP, SUITE 1000, 999 PEACHTREE STREET, ATLANTA, GA, 30309-3915, US

(73) Assignee: Victaulic Company, Easton, PA (US)

(21) Appl. No.: 11/843,147

(22) Filed: Aug. 22, 2007

(51) Int. Cl. A62C 35/62

(52) U.S. Cl. 169/17

(57) ABSTRACT

A module for testing and draining fire protection sprinkler systems is disclosed. The module has a chamber with an inlet duct in fluid communication with the sprinkler system and an outlet duct. A valve controls fluid flow through the chamber. A plate, having an orifice, is mounted within the chamber and is pivotable to a first or test position wherein the orifice is aligned with the outlet. Flow of water through the chamber is restricted by the orifice to simulate flow through a single open sprinkler head. The plate is pivotable to a second or drain position out of alignment with the outlet, allowing unrestricted flow. The module may include a pipe segment on which the module is mounted, the segment being integrated with a riser of the sprinkler system.

### FIELD OF THE INVENTION

This invention relates to a device for testing branches of fire suppression sprinkler systems and for draining the branches for servicing the system.

### BACKGROUND OF THE INVENTION

Fire suppression sprinkler systems are used in structures such as office buildings, hotels, apartment complexes, warehouses and residences and typically comprise a piping network which extends throughout the structure. The network is connected to a pressurized water source and may be divided into a plurality of branches, each of which extends through a different part of the structure. Sprinkler heads are mounted on the various branches and extend therefrom within rooms, hallways, stairwells and other parts of the structure. Each sprinkler head has a heat sensitive trigger which will cause the head to open during a fire in proximity to the head, spraying water on the fire to prevent its spread and help extinguish it.

There are two broad categories of sprinkler systems, wet systems and dry systems. In a wet system, water under pressure is always within the network branches when the system is in the ready mode (i.e., not being serviced or tested) to suppress a fire. In a dry system, water is not present in the branches but is permitted to flow to the network when a fire condition is sensed. Dry systems are used in structures which undergo large seasonal temperature variations, such as unheated warehouses, wherein the piping network may be subjected to freezing temperatures which could cause burst pipes if they are filled with water.

Sprinkler systems may use water flow detection alarms to provide an alert that one or more sprinkler heads are open and discharging water. Alarm devices may be positioned within each branch of the piping network and detect the opening of sprinkler heads within a branch. The opening of the head or heads could be indicative of a fire, in which case the structure is evacuated and firefighters are called to the scene to combat the blaze. Alternately, the head or heads could be opened inadvertently, for example, by mistake during servicing or as a result of damage to the sensitive trigger mechanism. Regardless of the cause of a sprinkler head opening, it is important to be able to detect and investigate such an occurrence.

The water flow detection alarms must be tested periodically to ensure their proper operation. It is required that the opening of a single sprinkler head within a branch create sufficient flow within the branch to trigger the alarm associated with that branch. This must be accomplished without actually opening a sprinkler head. Prior art testing systems simulate the opening of a sprinkler head with a complex set of valves which are expensive to purchase and install, difficult to operate and leak prone. It would be advantageous to provide a testing device which does not suffer the various disadvantages of the prior art systems.

### SUMMARY OF THE INVENTION

The invention concerns a test and drain module for testing and draining a branch of a piping network comprising a plurality of sprinkler heads. The test and drain module comprises an inlet duct in fluid communication with the piping network. An outlet duct is in fluid communication with the inlet duct. A valve is positioned between the inlet and the outlet ducts and controls flow of fluid between them. A chamber is positioned between the inlet and the outlet ducts. A body is positioned within the chamber. The body is movable between a first position in alignment with one of the ducts, and a second position out of alignment with the one duct. The body restricts the rate of fluid flow through the chamber to a first flow rate when in the first position and allows substantially unrestricted flow through the chamber when in the second position.

In one embodiment, the valve is positioned between the chamber and the inlet. The body may comprise a plate pivotably mounted within the chamber. A handle is attached to the plate for manually pivoting the plate into the first and second positions. Preferably, the plate has an orifice therethrough for permitting flow through the plate at the first flow rate. The first flow rate may equal the flow rate of liquid through an open sprinkler head.

In another embodiment, the test and drain module according to the invention comprises a pipe segment connectable within the branch of the piping network. The pipe segment has a bore surrounded by a sidewall. An inlet duct extends through the sidewall in fluid communication with the bore. An outlet duct is in fluid communication with the inlet duct. A valve is positioned between the inlet and the outlet ducts and controls flow of fluid between them. A chamber is positioned between the inlet and the outlet ducts. A body is positioned within the chamber. The body is movable between a first position in alignment with one of the ducts, and a second position out of alignment with the one duct. The body restricts the rate of fluid flow through the chamber to a first flow rate when in the first position and allows substantially unrestricted flow through the chamber when in the second position.

The valve may be positioned between the chamber and the inlet. Preferably, the body comprises a plate pivotably mounted within the chamber. A handle is attached to the plate for manually pivoting the plate into the first and second positions. Preferably, the plate has an orifice therethrough for permitting flow through the plate at the first flow rate. The first flow rate may equal the flow rate of liquid through an open sprinkler head.

The invention also encompasses a sprinkler system for fire suppression. The sprinkler system comprises a source of pressurized water and at least one piping network branch in fluid communication with the source. A plurality of sprinkler heads are mounted on the one branch for discharging water in the event of a fire. An inlet duct is in fluid communication with the one branch. An outlet duct is in fluid communication with the inlet duct. A valve is positioned between the inlet and the outlet ducts and controls flow of fluid between them. A chamber is positioned between the inlet and the outlet ducts. A body is positioned within the chamber. The body is movable between a first position in alignment with one of the ducts, and a second position out of alignment with the one duct. The body restricts the rate of fluid flow through the chamber to a first flow rate when in the first position, and allows substantially unrestricted flow through the chamber when in the second position. The first flow rate may be equal to the flow rate of liquid through one sprinkler head.

The inlet duct may extend through a sidewall of a pipe segment within the one branch. Alternately, the system may comprise a tee fitting within the one branch. The inlet duct is in fluid communication with the one branch through the tee fitting.

### BRIEF DESCRIPTION OF THE DRAWINGS

FIG. 1 is a schematic diagram of a sprinkler system including test and drain modules according to the invention;

FIG. 2 is a side view of one embodiment of a test and drain module according to the invention;

FIG. 3 is a sectional view taken at line 3-3 of FIG. 2;

FIG. 4 is a partial view of the test and drain module shown in FIG. 3 on an enlarged scale;

FIGS. 5 and 6 are sectional views of another embodiment of a test and drain module according to the invention; and

FIGS. 7 and 8 are sectional views of yet another embodiment of a test and drain module according to the invention.

### DETAILED DESCRIPTION OF THE EMBODIMENTS

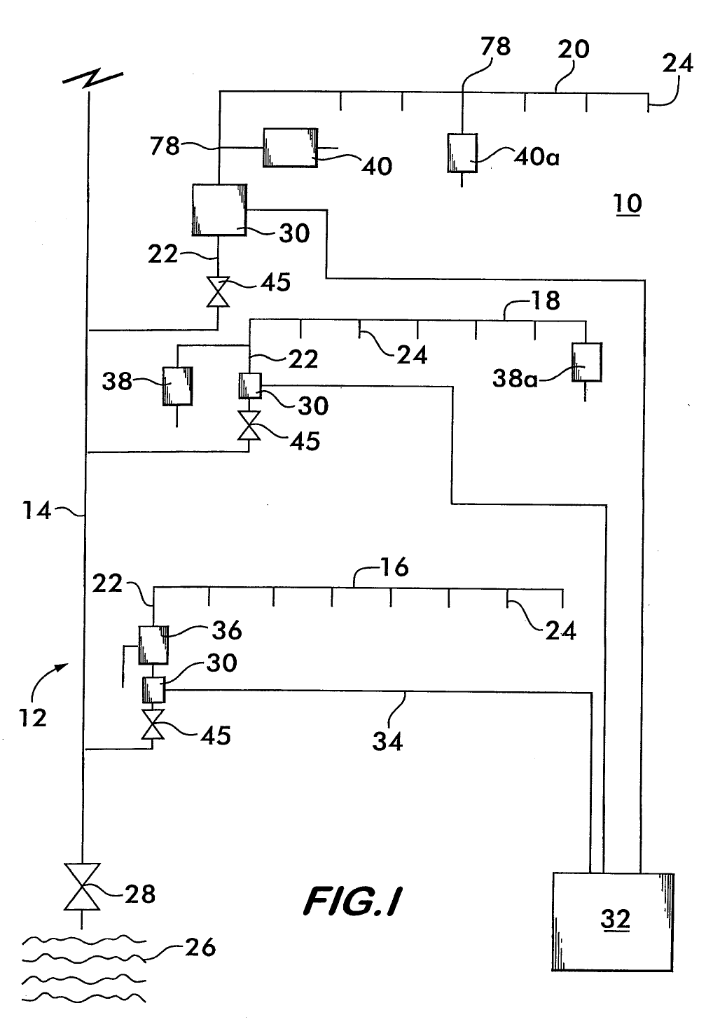

FIG. 1 is a schematic diagram of a fire suppression sprinkler system 10 according to the invention. System 10 comprises a piping network 12 including a main conduit 14 in fluid communication with a plurality of branches 16, 18 and 20. Each branch may serve a different part of the structure, such as a different floor, in which the network is located. The branches are connected to the main conduit by risers 22. Sprinkler heads 24 are mounted on the branches 16, 18 and 20. Each sprinkler head has a heat sensitive trigger that will open during a fire to discharge water onto the fire. The main conduit 14 is in fluid communication with a pressurized source of water 26, for example, the water main providing water service to the building or other structure served by the system 10. A valve 28 controls the flow of water from the source 26 to the network 12, allowing the system to be isolated for service and repairs.

Water flow through a branch resulting from one or more open sprinkler heads 24 is sensed by water flow detection devices 30, typically mounted on the risers 22 of each branch. The presence of water flow through a branch, once detected, is communicated to a central control system 32 over communication lines 34. The control system 32 is preferably electronic and may include a display panel which indicates which branch detects water flow. The control system may sound audible and visual alarms, and contact fire fighters in the event that an actual fire condition exists.

Each branch 16, 18 and 20 has a respective test and drain module 36, 38 and 40 which allows testing of an individual branch as well as draining of the branch for servicing and replacement of the sprinkler heads 24. The tests are required to ensure that water flow through at least one sprinkler head 24 in a branch will trigger the detection device 36 that signals an opening of a sprinkler head which can then be investigated to ascertain whether or not a fire condition exists.

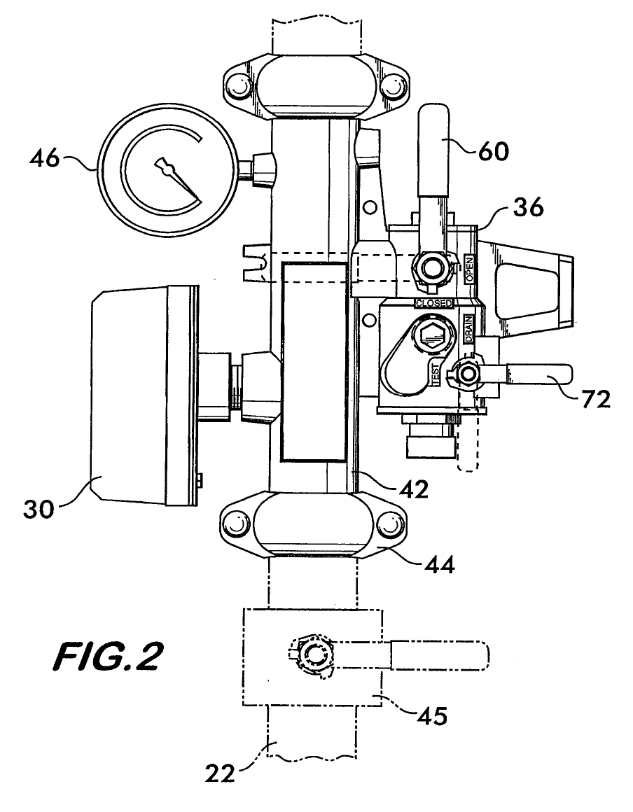

FIG. 2 shows the test and drain module 36 in branch 16. Module 36 comprises a pipe segment 42 that is connected in fluid communication with the riser 22 of branch 16 using couplings 44. The segment may of course be connected in other ways, for example, using bolted flanges or by welding or brazing. The riser 22 may also include a cut-off valve 45 positioned up-stream of the segment 42 for isolating branch 16 during draining as described below. In this embodiment, the fluid detection device 30 is mounted on the pipe segment 42 along with a pressure measurement device, such as a pressure gauge 46.

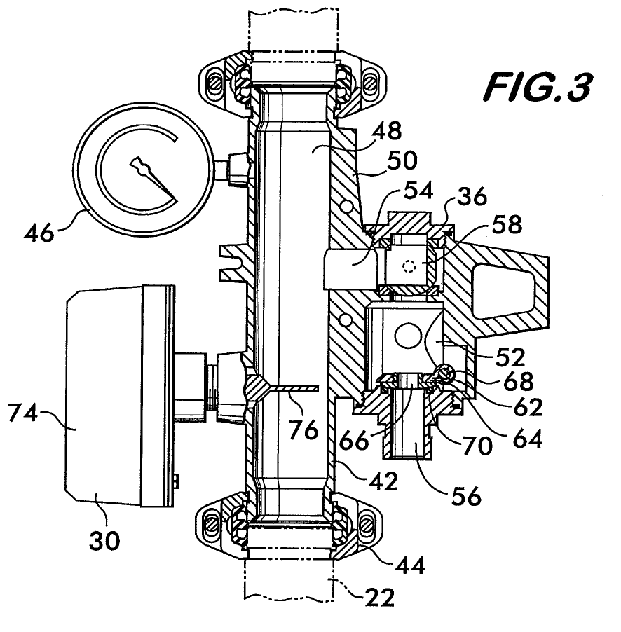

FIG. 3 is a sectional view of the module 36 showing a bore 48 of pipe segment 42 defined by a surrounding pipe sidewall 50. A chamber 52 is mounted on the pipe segment 42. Chamber 52 is in fluid communication with the bore 48 via an inlet duct 54 that extends through sidewall 50. Chamber 52 also has an outlet duct 56 in fluid communication with the inlet duct 54. A valve 58 is positioned between the inlet and outlet ducts and controls fluid flow between them. The valve is preferably a ball valve and is actuated manually by a handle 60 shown in FIG. 2. Other types of valves may also be used.

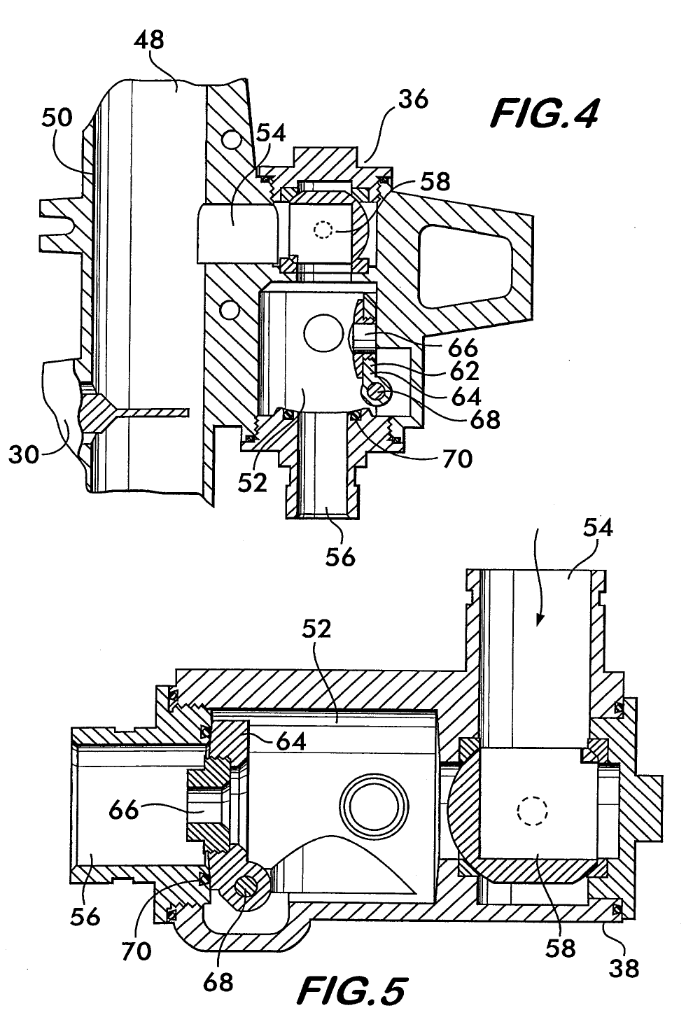

With reference again to FIG. 3, a body 62 is positioned within the chamber 52. Body 62 preferably takes the form of a plate 64 which is pivotably mounted within the chamber. The plate has an orifice 66 therethrough and is pivotable about an axis 68 between a first position, shown in FIG. 3, where it is in alignment with the outlet duct 56, and a second position, shown in FIG. 4, where it is out of alignment with the outlet duct 56. When in the first position, plate 64 sealingly engages a seat 70 which surrounds the outlet duct 56. The plate 64 is manually movable between the two positions using a handle 72, shown in FIG. 2. When the plate 64 is in the first position in alignment with outlet duct 54 (FIG. 3), it restricts the flow of fluid through the chamber 52. When in the second position out of alignment with the duct 54, flow through the chamber is substantially unrestricted. Orifice 66 is preferably sized so that water flowing through it flows at the same rate as through a single open sprinkler head, thus, allowing the module 36 to simulate the opening of a sprinkler head for testing the branch 16 of the system as described below.

Operation of the module 36 may be in one of two modes, namely, test or drain. To operate in the test mode, valve 58 starts out closed, as shown in FIG. 2 by the position of its handle 60 pointing to the “CLOSED” index on the outside of chamber 52. Handle 72, which controls the position of the plate 64 is rotated so that it points to the “TEST” index. These positions of the handles configure the valve 58 and plate 64 as shown in FIG. 3. Plate 64 is sealingly engaged with the seat 70 and aligned with the outlet duct 56. The valve 58 is then opened by turning handle 60. This permits water within the riser 22 to flow through the inlet duct 54, the valve 58, chamber 52, orifice 66 of plate 64 and out through the outlet duct 56 to a system drain (not shown). Water flows through the module 36 at a rate equal to the rate of flow through a single sprinkler head during the test due to the restriction of the flow as determined by the size of orifice 66. If the test is successful, the flow through the riser 22 will be sufficient to trip the detection device 30 which will send a signal to the central control 32 (see FIG. 1) indicating a successful system test. In this example, the detection device 30 comprises a flow meter 74 having a paddle 76 in the flow stream of the riser 22. The paddle is connected to a switch. When water flows past the paddle at a minimum threshold rate, the paddle is deflected by the force of the water, closing the switch and sending the desired signal. Other types of flow detection devices could also be used.

Upon completion of the test, or to replace one or more sprinkler heads 24 in the branch 16 (see FIG. 1), it is advantageous to drain the branch. This is accomplished by isolating the branch from the main conduit 14 by closing the cut-off valve 45 (see FIG. 2), rotating the handle 72 to the “DRAIN” index, and opening the valve 58. This configures the module 36 as shown in FIG. 4, with the plate 64 out of alignment with the outlet duct 56. Water in the branch 16 may flow back through the riser 22, through the inlet duct 54, the valve 58, the chamber 52 and through the outlet duct 56 to a system drain (not shown) substantially unrestricted. This permits rapid draining of the branch to effect repairs or service.

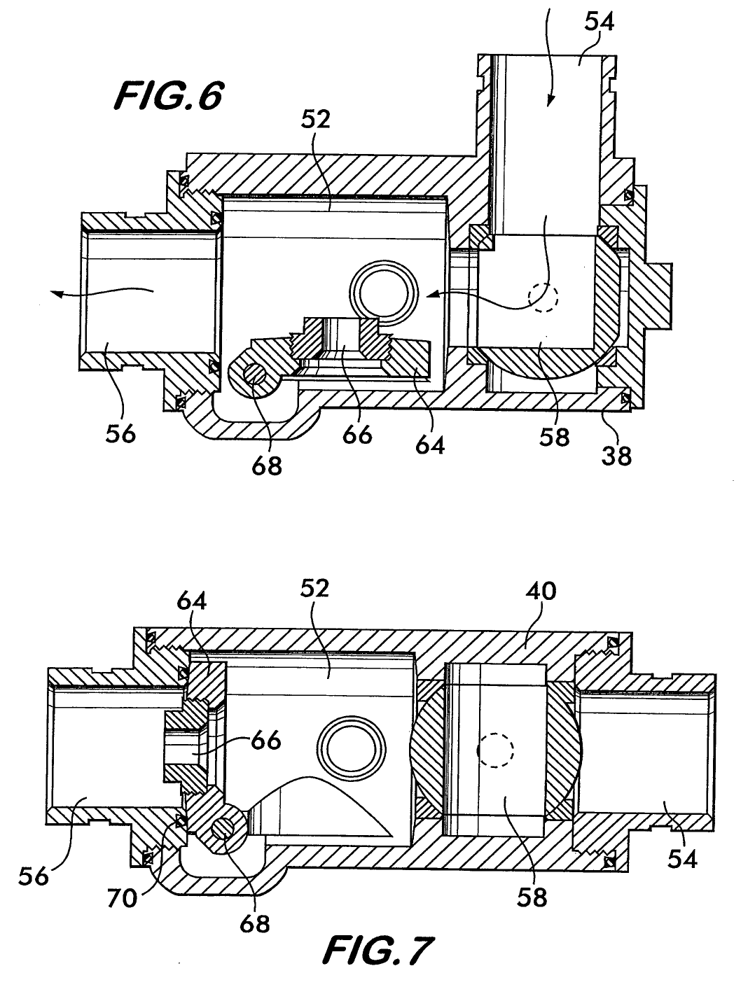

FIGS. 5 and 6 show another test and drain module 38 having an inlet duct 54 that is angularly oriented relatively to the outlet duct 56. The inlet duct is oriented at 90 degrees to the outlet duct in this example, but other angles are of course feasible. FIG. 5 shows the module 38 configured in its test mode with the plate 64 positioned in alignment with the outlet duct 56 and sealingly engaged with seat 70. The orifice restricts flow through the module, such that when valve 58 is opened the water flow rate through the module is equal to the flow rate through an open sprinkler head. FIG. 6 shows the module 38 in the drain configuration with the plate 64 pivoted out of alignment with the outlet duct 56, permitting unrestricted flow through the module to facilitate draining of the branch 18.

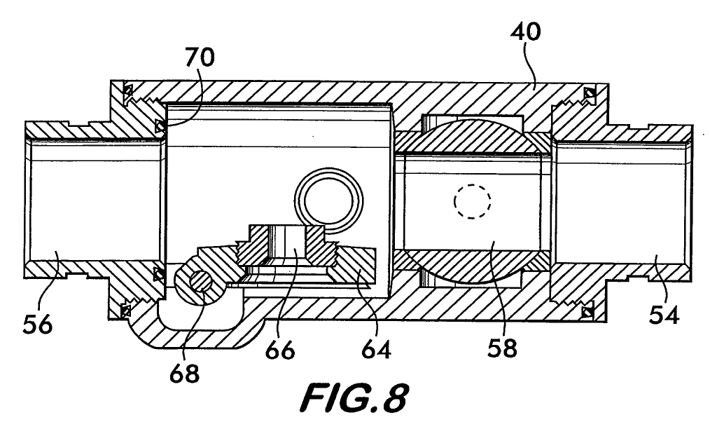

FIGS. 7 and 8 show another test and drain module 40 having an inlet duct 54 that is aligned with the outlet duct 56. FIG. 7 shows the module 40 configured in its test mode with the plate 64 positioned in alignment with the outlet duct 56 and sealingly engaged with seat 70. The orifice restricts flow through the module, such that when valve 58 is opened the water flow rate through the module is equal to the flow rate through an open sprinkler head. FIG. 8 shows the module 40 in the drain configuration with the plate 64 pivoted out of alignment with the outlet duct 56, permitting unrestricted flow through the module to facilitate draining of the branch 20.

The test and drain module embodiments 38 and 40 are advantageously positioned in risers 22 as shown in FIG. 1. This configuration allows convenient installation and operation of the modules in conjunction with the other elements of the system, such as the cut-off valve 45 and the flow detection device 30. A Tee coupling 78 may be used, for example, to provide fluid communication between the module and the riser 22 as shown for module 40 in branch 20.

In an alternate configuration, module embodiments 38 and 40 illustrated in FIGS. 5 and 7 are advantageously positioned within a branch as shown in FIG. 1, as opposed to on a portion of the riser 22 which feeds the branch. The module may be positioned at the terminal end of a branch, as shown for module 38a in branch 18, or at some intermediate point of a branch, as shown for module 40a in branch 20. Connection of module 40a to branch 20 may be effected by a Tee fitting 78.

Selectable mode test and drain modules according to the invention provide a device for testing and draining fire suppression sprinkler systems that is reliable, simple in design and operation, and easy to install and use, thereby providing significant advantages over prior art test and drain systems.

What is claimed is:

1. A test and drain module for testing and draining a branch of a piping network comprising a plurality of sprinkler heads, said test and drain module comprising:
an inlet duct in fluid communication with said piping network;
an outlet duct in fluid communication with said inlet duct;
a valve positioned between said inlet and said outlet ducts and controlling flow of fluid therebetween;
a chamber positioned between said inlet and said outlet ducts; and
a body positioned within said chamber, the body being movable between a first position in alignment with one of said ducts, and a second position out of alignment with said one of said ducts, the body restricting the rate of fluid flow through said chamber to a first flow rate when in said first position and allowing substantially unrestricted flow through said chamber when in said second position.

2. A test and drain module according to claim 1, wherein said valve is positioned between said chamber and said inlet.

3. A test and drain module according to claim 2, wherein said body comprises a plate pivotably mounted within said chamber.

4. A test and drain module according to claim 3, further comprising a handle attached to said plate for manually pivoting said plate into said first and second positions.

5. A test and drain module according to claim 3, wherein said plate has an orifice therethrough for permitting flow through said plate at said first flow rate.

6. A test and drain module according to claim 5, further comprising a seat positioned within said chamber adjacent to said plate and surrounding said outlet duct, said plate being sealingly engageable with said seat when in said first position.

7. A test and drain module according to claim 1, wherein said inlet duct is aligned with said outlet duct.

8. A test and drain module according to claim 1, wherein said inlet duct is angularly oriented with respect to said outlet duct.

9. A test and drain module according to claim 8, wherein said inlet duct is oriented at about 90 degrees to said outlet duct.

10. A test and drain module according to claim 1, wherein said valve comprises a ball valve.

11. A test and drain module according to claim 1, wherein said first flow rate is equal to the flow rate of liquid through one of said sprinkler heads.

12. A test and drain module for testing and draining a branch of a piping network comprising a plurality of sprinkler heads, said test and drain module comprising:
a pipe segment connectable within said branch, said pipe segment having a bore surrounded by a sidewall;
an inlet duct extending through said sidewall in fluid communication with said bore;
an outlet duct in fluid communication with said inlet duct;
a valve positioned between said inlet and said outlet ducts and controlling flow of fluid therebetween;
a chamber positioned between said inlet and said outlet ducts; and
a body positioned within said chamber, said body being movable between a first position in alignment with one of said ducts, and a second position out of alignment with said one of said ducts, said body restricting the rate of fluid flow through said chamber to a first flow rate when in said first position and allowing substantially unrestricted flow through said chamber when in said second position.

13. A test and drain module according to claim 12, wherein said valve is positioned between said chamber and said inlet.

14. A test and drain module according to claim 13, wherein said body comprises a plate pivotably mounted within said chamber.

15. A test and drain module according to claim 14, further comprising a handle attached to said plate for manually pivoting said plate into said first and second positions.

16. A test and drain module according to claim 14, wherein said plate has an orifice therethrough for permitting flow through said plate at said first flow rate.

17. A test and drain module according to claim 16, further comprising a seat positioned within said chamber adjacent to said plate and surrounding said outlet duct, said plate being sealingly engageable with said seat when in said first position.

18. A test and drain module according to claim 12, wherein said valve comprises a ball valve.

19. A test and drain module according to claim 12, wherein said first flow rate is equal to the flow rate of liquid through one of said sprinkler heads.

20. A test and drain module according to claim 12, further comprising a flow detector mounted on said pipe segment for detecting fluid flow therethrough.

21. A test and drain module according to claim 12, further comprising a pressure measurement device mounted on said piping segment.

22. A sprinkler system for fire suppression, said sprinkler system comprising:
a source of pressurized water;
at least one piping network branch in fluid communication with said source;
a plurality of sprinkler heads mounted on said one branch for discharging water in the event of a fire;
an inlet duct in fluid communication with said one branch;
an outlet duct in fluid communication with said inlet duct;
a valve positioned between said inlet and said outlet ducts and controlling flow of fluid therebetween;
a chamber positioned between said inlet and said outlet ducts; and
a body positioned within said chamber, said body being movable between a first position in alignment with one of said ducts, and a second position out of alignment with said one of said ducts, said body restricting the rate of fluid flow through said chamber to a first flow rate when in said first position and allowing substantially unrestricted flow through said chamber when in said second position.

23. A sprinkler system according to claim 22, wherein said inlet duct extends through a sidewall of a pipe segment within said one branch.

24. A sprinkler system according to claim 23, further comprising a flow detector mounted on said pipe segment for detecting fluid flow therethrough.

25. A sprinkler system according to claim 23, further comprising a pressure measurement device mounted on said piping segment.

26. A sprinkler system according to claim 22, further comprising a tee fitting within said one branch, said inlet duct being in fluid communication with said one branch through said tee fitting.

27. A sprinkler system according to claim 22, wherein said first flow rate is equal to the flow rate of liquid through one of said sprinkler heads.
